(19) United States
(12) Patent Application Publication
(10) Pub. No.: US 2022/0373814 A1
(43) Pub. Date: Nov. 24, 2022

(54) OPTICAL COMPONENT

(71) Applicant: Shanghai North Ocean Photonics Co., Ltd., Shanghai (CN)

(72) Inventors: Xinye Lou, Shanghai (CN); Yuhuang Meng, Shanghai (CN); He Huang, Shanghai (CN); Tao Lin, Shanghai (CN)

(21) Appl. No.: 17/636,796

(22) PCT Filed: Aug. 18, 2020
(86) PCT No.: PCT/CN2020/109862

§ 371 Date: Aug. 8, 2022

(30) Foreign Application Priority Data
Aug. 19, 2019 (CN) 201910763849.7
Apr. 30, 2020 (CN) 202010366157.1
Apr. 30, 2020 (CN) 202020704079.7

(51) Int. Cl. G02B 27/09; G02B 3/00; G01S 7/481; G01S 17/894

(52) U.S. Cl. CPC G02B 27/0905; G02B 27/0961; G02B 3/0062; G01S 7/4816; G01S 17/894

(57) ABSTRACT

Disclosed is an optical component (20) applied to a depth camera having a light source (11). The optical component (20) includes a light-homogenized element (21) having a microlens array (212) and a receiving lens (22). The light-homogenized element (21) is arranged on a light beam propagation path of the light source (11), and is used for modulating a light field emitted by the light source (11) of the depth camera to form a light beam which is not interfered to form light and dark stripes. The receiving lens (22) is adapted to a field angle of the light-homogenized element (21), and the receiving lens (22) is configured to allow at least a part of the light beam passing through the light-homogenized element (21) to enter the receiving lens (22) after being reflected by a target object. The optical component (20) is beneficial to acquiring complete and clear image information of a target object.

### TECHNICAL FIELD

The present disclosure relates to optical fields and, further, to an optical component suitable for a depth camera.

### BACKGROUND

With the development of science and technology, a depth camera technology has been greatly developed, and is widely used in smartphones, smart homes, intelligent vehicles, security devices, VR/AR gesture interaction and intelligent robots.

A time of flight (TOF) depth camera based on a TOF technology is one kind of depth cameras, a working principle of the TOF depth camera is as follows: the light emitting unit emits a light beam to a target object located in a certain angle field, the light beam is reflected by the target object and acquired by a light receiving unit, and the light beam acquired by the light receiving unit is analyzed based on the light beam emitted by the emitting unit, to obtain depth information of the target object.

It can be understood that in order to ensure the integrity and reliability of the acquired depth information, the light beam emitted by the TOF depth camera should be irradiated into a field range according to a certain optical field distribution and acquired by the light receiving unit, and a uniform light field should be formed at a receiving end. That is, an emitting end and the receiving end of the depth camera cooperate with each other and finally form a uniform light field within a certain field angle, so as to obtain the depth information of each point to be measured of the target object within the certain field angle, and reduce or avoid blind spots, bad spots or missing points, etc.

In conclusion, how to make the emitting end and the receiving end of the TOF depth camera cooperate to get more complete and reliable depth information of the target object, so as to improve the camera quality, is an urgent problem to be solved in the further development of TOF depth camera.

### SUMMARY

An advantage of the present disclosure is to provide an optical component to improve the reliability and integrity of the acquired light field.

Another advantage of the present disclosure is to provide an optical component, and the optical component is adapted to cooperate with a light emission device to improve the reliability and integrity of the acquired image information.

Another advantage of the present disclosure is to provide an optical component, and the optical component is used for modulating the light field emitted by the light emission device and receiving the modulated light field reflected by the target object to improve the integrity and reliability of the acquired image information.

Another advantage of the present disclosure is to provide an optical component, where the optical component includes a light-homogenized element and a receiving lens adapted to a field angle of the light-homogenized element. The light-homogenized element is arranged on a light beam propagation path of the light source and used for modulating a light field, and at least a part of the light beam after being reflected by a target object enters the receiving lens to acquire image information of the target object.

An advantage of the present disclosure is to provide an optical component, which has simple structure and convenient use.

Accordingly, in order to achieve at least one of the above inventive advantages, the present disclosure provides an optical component applied to a depth camera having a light source, and the optical component includes: a light-homogenized element having a microlens array and a receiving lens.

The light-homogenized element is arranged on a light beam propagation path of the light source, and is used for modulating a light field emitted by the light source of the depth camera to form a light beam which is not interfered to form light and dark stripes.

The receiving lens is adapted to a field angle of the light-homogenized element, and the receiving lens is configured to allow at least a part of the light beam passing through the light-homogenized element to enter the receiving lens after being reflected by a target object.

In an embodiment of the present disclosure, the field angle of the receiving lens in a horizontal direction and a vertical direction both take a value in a range of 1° to 150°.

In an embodiment of the present disclosure, the field angle of the receiving lens in the horizontal direction and the vertical direction are greater than or equal to 70°.

In an embodiment of the present disclosure, a relative illuminance of the light-homogenized element in a central preset field angle range gradually decreases toward a center direction of the light-homogenized element, and a relative illuminance of the receiving lens in the central preset field angle range gradually increases toward a center direction of the receiving lens.

In an embodiment of the present disclosure, the central preset field angle range in the horizontal direction and the vertical direction are 0° to 20°.

In an embodiment of the present disclosure, a range of a focal length of the receiving lens is 1 mm to 20 mm.

In an embodiment of the present disclosure, a range of an F number of the receiving lens is 0.6 to 10.

In an embodiment of the present disclosure, an imaging circle diameter of the receiving lens is greater than 6 mm.

In an embodiment of the present disclosure, a range of an optical distortion of the receiving lens is −10% to 10%.

In an embodiment of the present disclosure, the receiving lens is configured to adapt to a light source with a spectrum of 800 to 1100 nm.

In an embodiment of the present disclosure, a total track length of the receiving lens is less than or equal to 100 mm, and a back focal length of the receiving lens is greater than or equal to 0.1 mm.

In an embodiment of the present disclosure, the field angle of the light-homogenized element in a horizontal direction and a vertical direction both take a value in a range of 1° to 150°.

In an embodiment of the present disclosure, an output light intensity distribution of the light-homogenized element in the horizontal direction and the vertical direction are expressed as cos\hat{ }(−n) by a relationship between an output light intensity and an angle, and n is preset to take a value in a range of 0 to 20.

In an embodiment of the present disclosure, a transmittance of the light-homogenized element is greater than 80%.

In an embodiment of the present disclosure, a ratio of a light power in the field angle to a total power transmitted through the light-homogenized element is greater than 60%.

In an embodiment of the present disclosure, a total thickness of the light-homogenized element is preset within a range of 0.1 mm to 10 mm, and a thickness of the microlens array is preset between Sum and 300 um.

In an embodiment of the present disclosure, an overall size of the light-homogenized element is preset between 0.1 and 300 mm, and a size range of a length of a side of an effective region of the microlens array is preset to be between 0.05 and 300 mm.

In an embodiment of the present disclosure, the light-homogenized element includes a substrate, and the microlens array is formed on one surface of the substrate.

In an embodiment of the present disclosure, the receiving lens is a receiving optical lens based on a TOF technology.

Other objects and advantages of the present disclosure will be further embodied by the detailed description and the contents of the claims.

### BRIEF DESCRIPTION OF DRAWINGS

FIG. 1 is a block diagram of a depth camera according to an embodiment of the present disclosure;

FIG. 2 is a schematic diagram of a light beam propagation path of a depth camera according to an embodiment of the present disclosure;

FIG. 3 is output light intensity in a horizontal direction of a light-homogenized element satisfying specifications shown in a parameter table according to an embodiment of the present disclosure;

FIG. 4 is output light intensity in a vertical direction of a light-homogenized element satisfying specifications shown in a parameter table according to an embodiment of the present disclosure;

FIG. 5 is structural diagram of a receiving lens according to an embodiment of the present disclosure;

FIGS. 6A and 6B are receiving light intensities of a receiving lens in a horizontal direction and a vertical direction according to an embodiment of the present disclosure;

FIG. 7 is output illuminance at 1 m of a light-homogenized element satisfying specifications shown in a parameter table according to an embodiment of the present disclosure;

FIG. 8 is a block diagram of a receiving device and an optical component according to an embodiment of the present disclosure;

FIG. 9 is a coordinate diagram of a light-homogenized element according to an embodiment of the present disclosure;

FIG. 10 is a plan view of a rectangular microlens array of a light-homogenized element according to a first implement manner of an embodiment of the present disclosure;

FIG. 11 is a plan view of a circular microlens array of a light-homogenized element according to a first implement manner of an embodiment of the present disclosure;

FIG. 12 is a plan view of a triangular microlens array of a light-homogenized element according to a first implement manner of an embodiment of the present disclosure;

FIG. 13 is a structural diagram of a microlens array of a light-homogenized element according to a first implement manner of an embodiment of the present disclosure;

FIG. 14 is a light intensity distribution curve of a light-homogenized element according to a first modified implement manner of an embodiment of the present disclosure;

FIG. 15 is a coordinate diagram of a light-homogenized element according to a second implement manner of an embodiment of the present disclosure;

FIG. 16 is a plan view of a quadrate microlens array of a light-homogenized element according to a second implement manner of an embodiment of the present disclosure;

FIG. 17 is a plan view of a triangular microlens array of a light-homogenized element according to a second implement manner of an embodiment of the present disclosure;

FIG. 18 is a plan view of a trapezoidal microlens array of a light-homogenized element according to a second implement manner of an embodiment of the present disclosure;

FIG. 19 is a structural diagram of a microlens array of a light-homogenized element according to a second implement manner of an embodiment of the present disclosure; and

FIG. 20 is a light intensity distribution curve of a light-homogenized element according to a second implement manner of an embodiment of the present disclosure.

### DETAILED DESCRIPTION

The present disclosure is disclosed by the following description so as to be implemented by those skilled in the art. The preferred embodiments in the following description are used only by way of example, and those skilled in the art may conceive of other apparent variations. The basic principles, as defined in the following description, of the present disclosure may be applied to other embodiments, modifications, improvements, equivalents, and other solutions without departing from the spirit and scope of the present disclosure.

Those skilled in the art should be understood that in the description of the present disclosure, orientational or positional relationships indicated by terms “longitudinal”, “transverse”, “above”, “below”, “front”, “back”, “left”, “right”, “vertical”, “horizontal”, “top”, “bottom”, “inside”, “outside” and the like are based on the orientational or positional relationships illustrated in the drawings, which are merely for facilitating and simplifying the description of the present disclosure. These relationships do not indicate or imply that an device or component referred to have a specific orientation and is constructed and operated in a specific orientation, and thus it is not to be construed as limiting the present disclosure.

It may be understood that the term “one” should be regarded as “at least one” or “one or more”. That is, the number of an element may be one in an embodiment and the number of the element may be multiple in another embodiment. The term “one” should not be considered to limit the number.

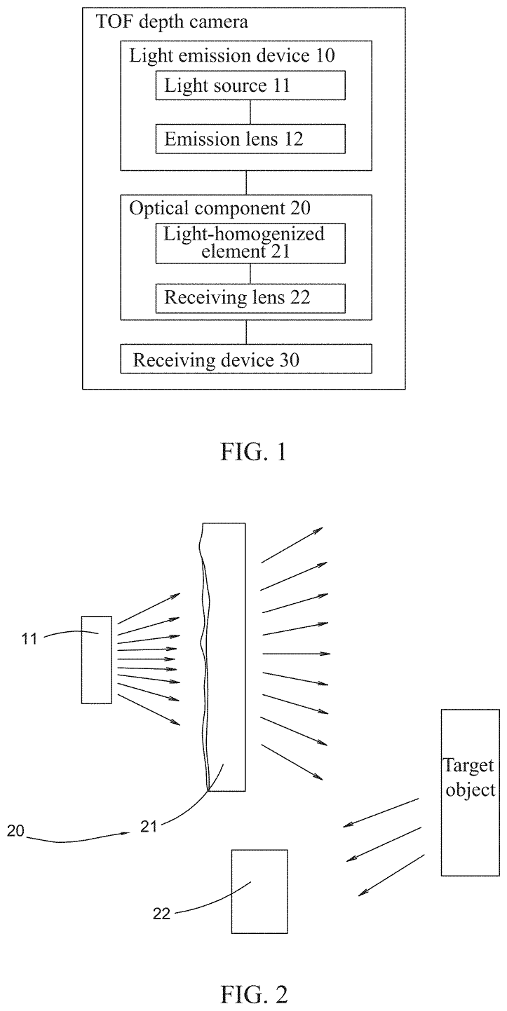

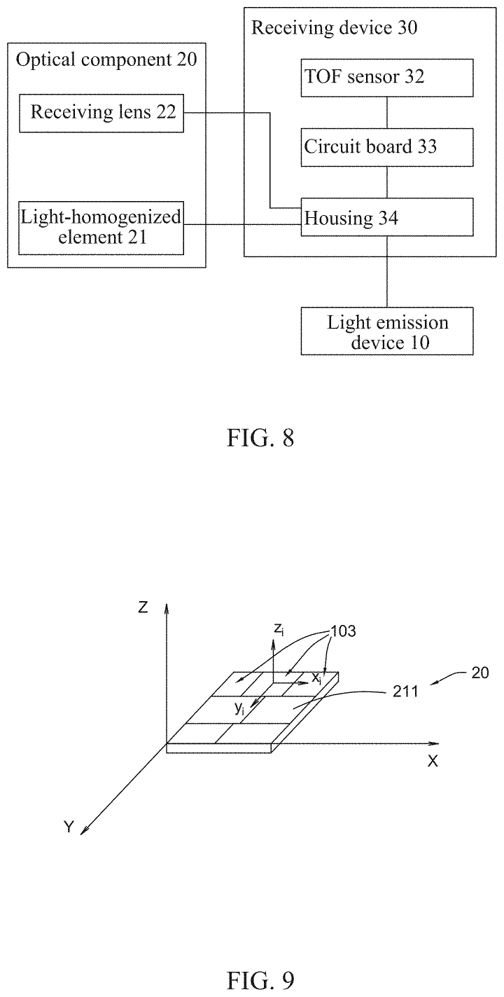

A TOF depth camera provided by the present disclosure is described with reference to FIGS. 1 to 20. The TOF depth camera includes a light emission device 10 and a receiving device 30. The light beam emitted by the light emission device 10 irradiates a target object, is reflected by the target object and enters the receiving device 30 to obtain image information of the target object.

The TOF depth camera of the present disclosure includes an optical component 20, the optical component 20 includes a light-homogenized element 21 and a receiving lens 22, and a field angle of the receiving lens 22 is adapted to the light-homogenized element 21. The light-homogenized element 21 is arranged on a light beam propagation path of the light source 11, and the light emitted by the light source 11 passes through the light-homogenized element 21 before reaching the target object. The light reflected by the target object passes through the receiving lens 22 and then enters the receiving device 30 so that the image information of the target object is obtained.

The light-homogenized element 21 and the receiving lens 22 of the present disclosure are components of the light emission device 10 and the receiving device 30, respectively. In an embodiment, the light emission device 10 includes a light source 11 and a light-homogenized element 21, and may further include an emission lens 12 such as a collimation lens. The light source 11 is used for emitting a light field, and the light field emitted by the light source 11 is emitted out through the emission lens 12 and the light-homogenized element 21. The light field reflected by the target object enters the receiving device 30 so that the image information of the target object is obtained.

The receiving device 30 may be a facing toward infrared imaging device, and includes a receiving lens 22, a TOF sensor 32, a circuit board 33 and a housing 34, where the light-homogenized element 21, the light source 11, the receiving lens 22, the TOF sensor 32 and the circuit board 33 are all installed in the housing 34. The reflected light of the light-homogenized beam reflected by a target scene reaches the TOF sensor 32 through the receiving lens 22 and is converted into an electrical signal and the electrical signal is transmitted to the circuit board 33, where the circuit board 33 is electrically connected to the light source 11, the receiving lens 22 and the TOF sensor 32, and the circuit board 33 is used for processing and obtaining depth information. The circuit board 33 is electrically connected to an application terminal to transmit the image information to the application terminal. In other words, the receiving device 30 acquires depth information of the target scene based on the TOF technology, and feeds back the depth information to the application terminal.

It should be noted that the adaptation between the field angle of the structural lens 22 and the light-homogenized element 21 means that the light emitted through the optical component 20 can at least partially enter the receiving lens 22 after being reflected by the target object.

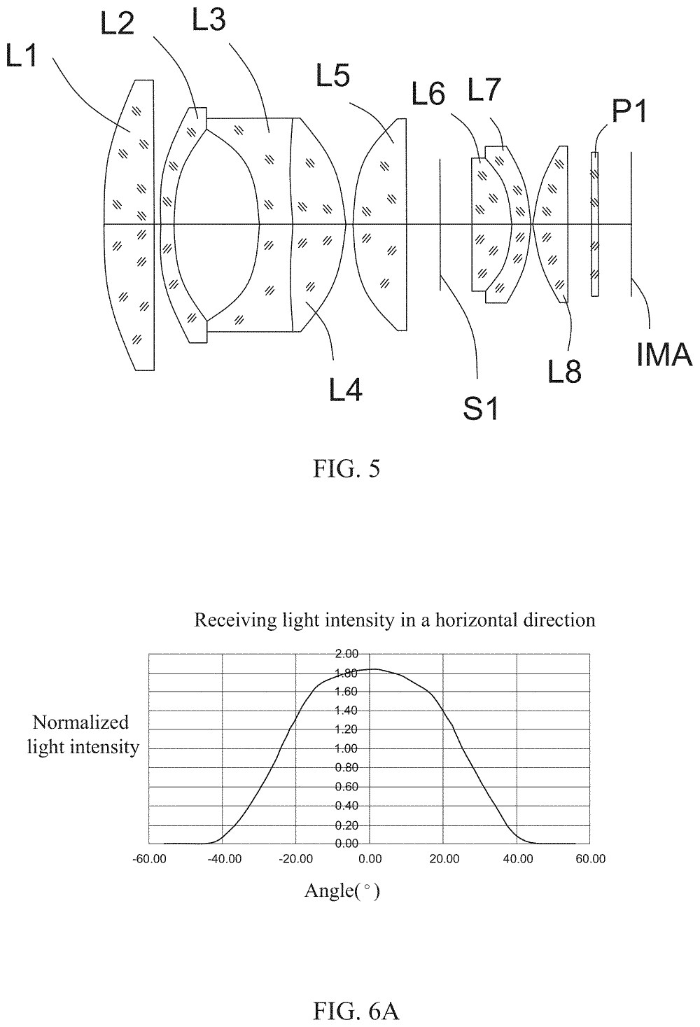

Referring to FIG. 5, in an embodiment, the receiving lens 22 is a TOF optical lens including an optical member disposed in a lens cone, such as one or more lenses. For example, the optical member is sequentially provided, from an object plane to an image plane, with a first positive focal power meniscus lens L1, a second negative focal power meniscus lens L2, a third negative focal power biconcave lens L3, a fourth positive focal power biconvex lens L4, a fifth positive focal power biconvex lens L5, an aperture diaphragm S1, an adhesive lens composed of a sixth positive focal power biconvex lens L6 and an seventh negative focal power meniscus lens L7, an eighth positive focal power meniscus lens L8 and a parallel glass plate P1 located before the image plane.

In an embodiment, the distance between the first positive focal power meniscus lens L1 and the second negative focal power meniscus lens L2 is 0.05-0.15 mm, the distance between the second negative focal power meniscus lens L2 and the third negative focal power biconcave lens L3 is 3.0-3.5 mm, the distance between the third negative focal power biconcave lens L3 and the fourth positive focal power biconvex lens L4 is 0.05-0.15 mm, the distance between the fourth positive focal power biconvex lens L4 and the fifth positive focal power biconvex lens L5 is 0.05-0.15 mm, the distance between the fifth positive focal power biconvex lens L5 and the sixth positive focal power biconvex lens L6 is 4-5 mm, and the distance between the seventh negative focal power meniscus lens L7 and the eighth positive focal power meniscus lens L8 is 0.05-0.15 mm.

Further, the focal length of the receiving lens 22 is set to be f, the focal length of the first positive focal power meniscus lens L1 is set to be f1, the focal length of the second negative focal power meniscus lens L2 is set to be f2, the focal length of the third negative focal power meniscus lens L3 is set to be f3, the combined focal length of the fourth positive focal power biconvex lens L4 and the fifth positive focal power biconvex lens L5 is set to be fa, the focal length of the eighth positive focal power meniscus lens L8 is f8, and the above focal lengths satisfies the following relationship: 3.0<f1/f<5.0, −1.5<f2/f<−1, 0.5<fa/f<2, 1<f8/f<4.5.

In this embodiment, the glass refractive indexes of the fourth positive focal power biconvex lens L4, the fifth positive focal power biconvex lens L5 and the eighth focal positive focal power meniscus lens L8 are n4, n5 and n8, respectively, and satisfy the following relationships: 1.5<n4<2.0, 1.5<n5<2.0, 1.5<n8<2.0.

In this embodiment, an optical surface serial number S1 represents an optical surface of the first positive focal power meniscus lens L1 facing toward the object surface, and an optical surface serial number S2 represents an optical surface of the first positive focal power meniscus lens L1 facing toward the image surface. An optical surface serial number S3 represents an optical surface of the second negative focal power meniscus lens L2 facing toward the object surface, and the optical surface serial number S4 represents an optical surface of the second negative focal power meniscus lens L2 facing toward the image surface. An optical surface serial number S5 represents an optical surface of the third negative focal power biconcave lens L3 facing toward the object surface, and the optical surface serial number S6 represents an optical surface of the third negative focal power biconcave lens L3 facing toward the image surface. An optical surface serial number S7 represents an optical surface of the fourth positive focal power biconvex lens L4 facing toward the object surface, and the optical surface serial number S8 represents an optical surface of the fourth positive focal power biconvex lens 14 facing toward the image surface. An optical surface serial number S9 represents an optical surface of the fifth positive focal power biconvex lens L5 facing toward the object surface, and an optical surface serial number S10 represents an optical surface of the fifth positive focal power biconvex lens L5 facing toward the image surface. An optical surface serial number S12 represents an optical surface of the sixth positive focal power biconvex lens L6 facing toward the object surface, and an optical surface serial number S13 represents an optical surface of the sixth positive focal power biconvex lens L6 facing toward the image surface. An optical surface serial number S14 represents an optical surface of the seventh negative focal power meniscus lens L7 facing toward the image plane. An optical surface serial number S15 represents an optical surface of the eighth positive focal power meniscus lens L8 facing toward the object surface, and the optical surface serial number S16 represents an optical surface of the eighth positive focal power meniscus lens L8 facing toward the image surface. The thickness represents a center distance between the current optical surface and the next optical surface. A middle surface coincidence surface of a double adhesive lens represented by the adhesive lens formed by the sixth positive focal power biconvex lens L6 and the seventh negative focal power meniscus lens L7 is S13, a surface of the seventh negative focal power meniscus lens L7 facing toward an image side is S15, and a refractive index corresponds to the refractive index of the lens.

An S1 cambered surface of the first positive focal power meniscus lens L1 has an R value in the range of 14-15 mm, a thickness in the range of 1.75-1.85 mm, a glass refractive index in the range of 1.85-1.95, and a glass Abbe number in the range of 33-38.

An S2 cambered surface of the first positive focal power meniscus lens L1 has an R value in the range of 65-75 mm, a thickness in the range of 0.1-0.3 mm, a glass refractive index in the range of 1.85-1.95, and a glass Abbe number in the range of 33-38.

An S3 cambered surface of the second negative focal power meniscus lens L2 has an R value in the range of 9-12 mm, a thickness in the range of 0.5-1 mm, a glass refractive index in the range of 1.8-1.9, and a glass Abbe number in the range of 20-26.

An S4 cambered surface of the second negative focal power meniscus lens L2 has an R value in the range of 3-3.5 mm, a thickness in the range of 3-3.5 mm, a glass refractive index in the range of 1.85-1.9, and a glass Abbe number in the range of 20-26.

An S5 cambered surface of the third negative focal power biconcave lens L3 has an R value in the range of −4.0 to −3.5 mm, a thickness in the range of 0.5-1.5 mm, a glass refractive index in the range of 1.75-1.85, and a glass Abbe number in the range of 20-25.

An S6 cambered surface of the third negative focal power biconcave lens L3 has an R value in the range of 15 to 20 mm, a thickness in the range of 1.5-2.0 mm, a glass refractive index in the range of 1.75-1.85, and a glass Abbe number in the range of 20-25.

An S7 cambered surface of the fourth positive focal power biconvex lens L4 has an R value in the range of 22-25 mm, a thickness in the range of 1.5-2.0 mm, a glass refractive index in the range of 1.85-1.95, and a glass Abbe number in the range of 30-38.

An S8 cambered surface of the fourth positive focal power biconvex lens L4 has an R value in the range of −6.0 to −5.5 mm, a thickness in the range of 0.05-0.15 mm, a glass refractive index in the range of 1.85-1.95, and a glass Abbe number in the range of 30-38.

An S9 cambered surface of the fifth positive focal power biconvex lens L5 has an R value in the range of 5-10 mm, a thickness in the range of 1-2 mm, a glass refractive index in the range of 1.85-1.95, and a glass Abbe number in the range of 30-38.

An S10 cambered surface of the fifth positive focal power biconvex lens L5 has an R value in the range of −90 to 85 mm, a thickness in the range of 2-3 mm, a glass refractive index in the range of 1.85-1.95, and a glass Abbe number in the range of 30-38.

An S12 cambered surface of the sixth positive focal power biconvex lens L6 has an R value in the range of 30-35 mm, a thickness in the range of 1.5-2.0 mm, a glass refractive index in the range of 1.5-1.7, and a glass Abbe number in the range of 50-60.

An S13 cambered surface of the sixth positive focal power biconvex lens L6 has an R value in the range of −3.0 to −2.5 mm, a thickness in the range of 0.5-1.0 mm, a glass refractive index in the range of 1.9-2.0, and a glass Abbe number in the range of 15-20.

An S14 cambered surface of the seventh negative focal power meniscus lens L7 has an R value in the range of −10 to −9 mm, a thickness in the range of 0.5-1.5 mm, a glass refractive index in the range of 1.5-1.7, and a glass Abbe number in the range of 15-20.

An S15 cambered surface of the eighth positive focal power biconvex lens L8 has an R value in the range of 8-12 mm, a thickness in the range of 1.1-1.5 mm, a glass refractive index in the range of 1.5-2.0, and a glass Abbe number in the range of 40-45.

An S16 cambered surface of the eighth positive focal power biconvex lens L8 has an R value in the range of 300-320 mm, a thickness in the range of 2.5-5 mm, a glass refractive index in the range of 1.5-2.0, and a glass Abbe number in the range of 40-45.

Further, performance parameters of the receiving lens 22 satisfy that: the focal length is 1 mm to 20 mm, F number is 0.6 to 10, the field angle is 270°, an imaging circle diameter is greater than 6.0 mm, a range of optical distortion is −10% to 10%, an adaptive light source spectrum is 800 to 1100 nm, the total track length (TTL)≤100 mm, the back focal length>0.1 mm, and the receiving lens 22 is particularly suitable for a TOF chip with one megapixel high-resolution.

It should be noted that the receiving lens 22 has a relatively high resolution and can satisfy the modulation transfer function (MTF) requirements of the TOF chip with one megapixel. The receiving lens 22 also has a very low optical distortion and can satisfy some application scenes in which TOF low distortion requirements are required.

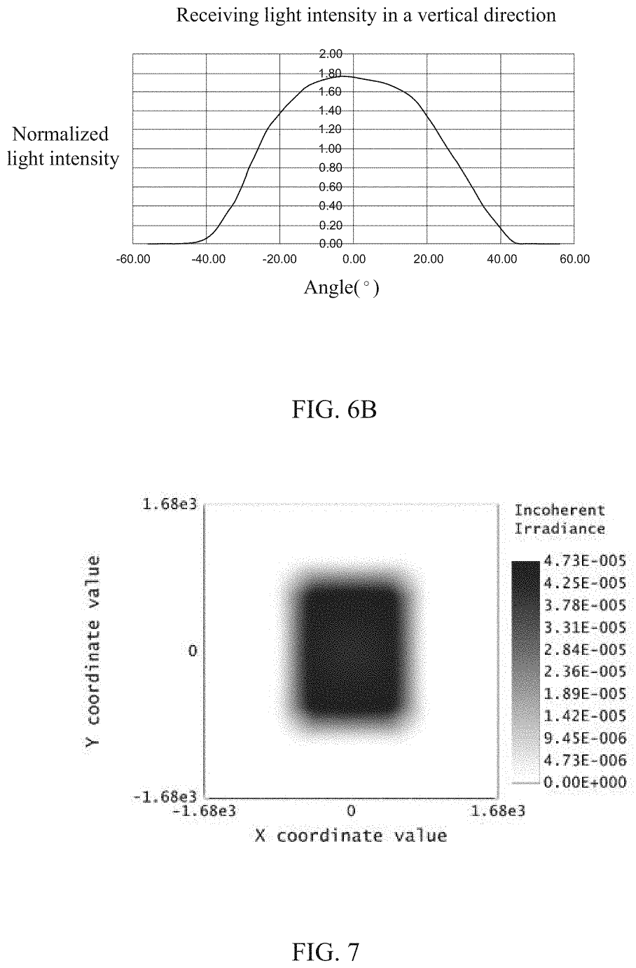

Referring to FIGS. 6A and 6B, FIGS. 6A and 6B display a correspondence relationship between the field angle and the received light intensity in the horizontal direction of the receiving lens 22. However, it should be noted that a relative illuminance of the light-homogenized element 21 in a central preset field angle range gradually decreases toward a center direction, and a relative illuminance of the receiving lens 22 in the central preset field angle range gradually increases toward the center direction, so that the collocation of the receiving lens 22 and the light-homogenized element reduces the exposure unevenness and improves the imaging quality. For example, the central preset field angle range in the horizontal direction and the vertical direction are within the field angle range of 0° to 20°.

In an embodiment, the light source 11 is implemented as a laser emission unit for emitting a laser beam such as infrared light. Alternatively, the light source 11 may be implemented as a laser emission array or a vertical cavity surface laser emitter. The light source 11 can emit a light beam at a predetermined angle or direction, where the light beam should be irradiated into a desired field angle range according to a certain light field distribution. The light beam emitted from the light source 11 has a certain wavelength, where a range of the wavelength of the light beam emitted from the light source 11 is approximately within 800 nm to 1100 nm. The wavelength of the light beam emitted from the light source 11 is generally preset to 808 nm, 830 nm, 850 nm, 860 nm, 940 nm, 945 nm, 975 nm, 980 nm, 1064 nm or the like according to different imaging requirements, and which is not limited herein.

Further, as shown in FIG. 2, the light-homogenized element 21 is provided in front of the light beam emitted from the light source 11, and the distance D1 is maintained between the light-homogenized element 21 and a light emitting surface of the light source 11. When the TOF depth camera is shooting, the light beam emitted from the light source 11 is subjected to the light-homogenized action of the light-homogenized element 21 to form a light-homogenized beam, where the light-homogenized beam irradiates the target scene at a certain field angle, and the light-homogenized beam is not interfered to form light and dark stripes, that is, the light-homogenized beam with a continuous specific light intensity distribution is formed, so as to finally form a uniform light field. In other words, the light beam after being processed by the light-homogenized element 21 forms a light-homogenized beam which will not be interfered to form the light and dark stripes, so that the receiving device 30 forms a uniform light field for measuring the depth information of each point location of the target object, thereby reducing or avoiding the occurrence of blind spots, bad spots, missing spots, etc., thereby further making the image information more complete and reliable, thus improving the imaging quality.

The light-homogenized element 21 includes a substrate 211 and a random regularized microlens array 212 formed on one surface of the substrate 211. The microlens array 212 includes a group of microlens units 2121 arranged randomly and regularly, where part parameters or random variables of the microlens units 2121 are different and the microlens units 2121 are not arranged periodical-regularly. The light emitted by the light source 11 is acted by the microlens array 212 to form a light-homogenized beam. Since the microlens unit 2121 are different from one other and not arranged periodical-regularly, unlike the traditional regularly arranged microlens array, the problem that light beam is interfered through the traditional regular microlens array and forms the light and dark stripes is effectively avoided, so that the light and dark stripes will not be formed caused by interference between light-homogenized beams, thereby reducing or avoiding the phenomenon that part point locations or regions of the target scene cannot be fully and uniformly irradiated by the light beam, i.e., ensuring that each point location of the target scene can be fully irradiated by the light beam, and further ensuring the integrity and reliability of the depth information, so that it is beneficial to improving the camera quality of the dimension-increasing information acquisition device.

In other words, part parameters or random regular variables of each microlens unit 2121 are preset with random regular changes within a certain range, so that each microlens unit 2121 has a randomly regulated shape size or spatial arrangement, that is, the shapes and sizes of any two microlens units 2121 are different from each other, and the arrangement mode is irregular, so as to prevent the interference of light beams during propagation in space, and improve the light-homogenized effect, and thereby satisfying the regulate and control of the spot scattering pattern and light intensity distribution of the required target scene.

In an embodiment, the microlens unit 2121 has an aspheric surface type which is an optical structure with a focal power function. For example, the microlens unit 2121 may be a concave-type lens or a convex-type lens and is not specifically limited here. By performing a random regularization processing, i.e., a modulation process, on part parameters or variables of the microlens unit 2121, the regulation and control of the spot pattern and the light intensity distribution of the required target scene can be achieved. Part parameters of the microlens unit 2121 include, but are not limited to, a curvature radius, a conical constant, an aspheric surface coefficient, a shape and size of an effective clear aperture of the microlens unit 2121, i.e., cross-sectional profile of the microlens unit 2121 on an X-Y plane, spatial arrangement of the microlens units 2121, and surface profile of the microlens unit 2121 in a Z-axis direction, etc.

According to the imaging requirements of different application scenes, part parameters or variables of the microlens unit 2121 of the microlens array 212 are preset to randomly and regularly take values within the corresponding range, so that the regulation and control of the light spot pattern and light intensity distribution of the light field of the corresponding target scene is achieved to match and adapt to different imaging scenes.

The microlens array 212 is formed on the surface of the substrate 211, such as a surface of a side of the substrate 211 opposite to the light source 11. Alternatively, in this embodiment, the microlens array 212 is formed on a side surface of the substrate 211 facing toward the light source 11. The substrate 211 may be made of a transparent material, such as a plastic material, a resin material, a glass material, or the like. In order to prevent the light beam from propagating forward directly through the substrate 211, the microlens array 212 should cover the surface of the substrate 211 as completely as possible, so that the light beam generated by the light source 11 propagates forward as fully as possible through the microlens array 212. In other words, the microlens units 2121 of the microlens array 212 are arranged as closely as possible on the surface of the substrate 211 and a surface coverage is as high as possible.

In order to obtain more complete and reliable depth information and improve the image quality, the present embodiment provides the value ranges of part specification parameters of the light-homogenized element 21.

Based on the principle of light refraction, the light-homogenized element 21 refracts the light beam 21 to form a light-homogenized beam, so that the light-homogenized beam will not be interfered to form light and dark stripes. That is, after the light beam is refracted and transmitted by the light-homogenized element 21, the light-homogenized beam is formed and projected to the target scene.

The field angle of the light-homogenized element 21 in the horizontal direction and the vertical direction are substantially within a range of 1° to 150°. According to different camera requirements, the range of the field angle may also be preset and adjusted. For example, for depth dimension-increasing information acquisition devices of some mobile terminals, the depth camera is preset to form a uniform light field within the range of 40° to 90°. Alternatively, for some special application scenes, for example, the depth camera is applied to the household intelligent sweeping robot, and the depth camera is preset to form a uniform light field within a range of the specified field angle to ensure the accuracy and reliability of the household intelligent sweeping robot, correspondingly.

Correspondingly, the field angle of the receiving lens 22 in the horizontal direction and the vertical direction are substantially within a range of 1° to 150° for matching with the field angle of the light-homogenized element 21.

An output light intensity distribution of the depth camera in the horizontal direction and the vertical direction are expressed as cos\hat{ }(−n) by a relationship between an output light intensity and an angle, and a value of n is related to the field angle and the characteristics of the sensor of the depth camera. In this embodiment, the value of n is preset to be in a range of 0 to 20, that is, the output light intensity distribution in the horizontal direction and the vertical direction are expressed in the range of cos\hat{ }(0) to cos\hat{ }(−20) by the relationship between an output light intensity and an angle. It should be understood by those skilled in the art that the output light intensity distribution may also be ranged by other forms of expressions, this embodiment is only taken as an example, and the output light intensity distribution of the depth camera may be adjusted correspondingly according to different imaging requirements or target scenes, which is not limited herein.

The transmittance of the light-homogenized element 21 is substantially greater than or equal to 80%, that is, the ratio of the radiant energy of the light-homogenized beam to the radiant energy of the light beam or the ratio of the total emitting power to the total input power is greater than or equal to 80%. It is well known that the transmittance is generally closely related to the material properties of the light-homogenized element 21. Therefore, according to different imaging requirements or different application scenes, in order to provide an appropriate transmittance, the light-homogenized element 21 may be made of a material corresponding to the transmittance, or a combined material, etc. For example, the transmittance of the light-homogenized element 21 is greater than or equal to 90%.

The window efficiency of the depth camera is defined as the proportion of the light power in the field angle to the total light power transmitted through the light-homogenized element 21, which represents the energy utilization rate of the light-homogenized element 21 to a certain extent, and the higher the window efficiency value is, the better the light-homogenized element 21 is. In this embodiment, the window efficiency of the depth camera has a value of more than 60%, for example, a value of more than 70%.

Based on the wavelength of the light beam emitted from the light source 11, the operating wavelength range of the light-homogenized element 21 is for example, preset to set a tolerance of ±10 nm on the basis of the wavelength of the light beam emitted from the light source 11, so as to adapt to the drift of the wavelength of the light beam emitted from the light source 11 under the environment change of the target scene and to ensure the imaging quality. It can be understood that the operating wavelength range of the light-homogenized element 21 may be preset to set a tolerance of ±20 nm on the basis of the wavelength of the light beam.

The distance D between the light-homogenized element 21 and the light emitting surface of the light source 11 is preset to a corresponding distance value according to the different scenes to which the depth camera is applied or the different types of the application terminal. In this embodiment, the distance D is preset between 0.1 mm and 20 mm, and the value of the distance D will be different in different application scenes. For example, the depth camera is applied to a mobile phone terminal. In order to satisfy a miniaturization requirement, the volume or size of the depth camera should be reduced as much as possible. Therefore, the distance D between the light-homogenized element 21 and the light source 11 is generally controlled to be less than 0.5 mm, for example, the distance D is about 0.3 mm. For another example, the depth camera is applied to the household intelligent sweeping robot. Since the household intelligent sweeping robot has relatively high tolerability to the volume or size of the depth camera, the distance D between the light-homogenized element 21 and the light source 11 may be preset to be several millimeters or even tens of millimeters, and is not limited here.

The total thickness of the light-homogenized element 21 is substantially within the range of 0.1 mm to 10 mm, i.e., the sum of the thicknesses of the microlens array 212 and the thicknesses of the substrate 211. Further, the thickness of the microlens array 212 of the light-homogenized element 21 is, for example, between Sum and 300 um.

In order to ensure that a uniform light field is formed, based on different application scenes or the structure of the depth camera, the overall size range of the light-homogenized element 21 is substantially between 0.1 mm and 300 mm, and a size range of a length of a side of an effective region of the microlens array 212 is substantially between 0.05 mm and 300 mm. The effective region of the microlens array 212 refers to a region where the light beam forms a light-homogenized beam through the microlens array 212, that is, the total region formed by the arrangement of the microlens units 2121. For example, an arrangement region of the microlens array 212 is substantially equal to a horizontal region of the substrate 211.

The above embodiment is an example of the value range of the part of specification parameters of the depth camera provided in this embodiment. Of course, the value range of the part of specification parameters of the depth camera can be adaptively adjusted according to actual imaging requirements or different application scenes, and is not limited here.

Table 1 below shows a part of specification parameter table of the light-homogenized element 21 of the depth camera provided in this embodiment.

TABLE 1

| | Parameter | Small | Convention | Large | Unit | Description |
|---|---|---|---|---|---|---|
| 1 | Parameter of the | Refraction type | | | — | Refraction or reflection |
| | light-homogenized | | | | | |
| | element 21 | | | | | |
| 2 | Field angle in the | 82 | | 84 | ° | Defined as a full range of 50% central |
| | horizontal direction | | | | | intensity, designed and tested using the |
| 3 | Field angle in the | 69 | | 71 | ° | designated light source 11 |
| | vertical direction | | | | | |
| 4 | Output light intensity | | 4 | | | Usually fitted as cos \hat{ } (-n) according to the |
| | distribution in the | | | | | relationship between the light intensity and |
| | horizontal direction | | | | | the angle |
| 5 | Output light intensity | | 4 | | | |
| | distribution in the | | | | | |
| | vertical direction | | | | | |
| 6 | Transmittance of the | 90 | | | % | Ratio of the total emitting power to the total |
| | light-homogenized | | | | | input power |
| | element 21 | | | | | |
| 7 | Window efficiency | 75 | | | % | Ratio of the total power to the total |
| | | | | | | transmission power in a region within the |
| | | | | | | field angle range |
| 8 | Operating | 930 | 940 | 950 | nm | |
| | wavelength range | | | | | |
| 9 | Distance D between | 0.25 | 0.30 | 0.35 | mm | |
| | the | | | | | |
| | light-homogenized | | | | | |
| | element 21 and the | | | | | |
| | light source 11 | | | | | |
| 10 | Material of the | D263 | | | | |
| | substrate 211 | | | | | |
| 11 | Material of the | Polymer | | | | Sulfur-free polymer |
| | microlens array 212 | | | | | |
| 12 | Thickness of the | 0.45 | 0.5 | 0.55 | mm | |
| | light-homogenized | | | | | |
| | element 21 | | | | | |
| 13 | Horizontal size of the | 2.95 | 3 | 3.05 | mm | |
| | light-homogenized | | | | | |
| | element 21 | | | | | |
| 14 | Vertical size of the | 2.45 | 2.5 | 2.55 | mm | |
| | light-homogenized | | | | | |
| | element 21 | | | | | |
| 15 | Horizontal effective | 2.55 | 2.6 | 2.65 | mm | |
| | region of the | | | | | |
| | light-homogenized | | | | | |
| | element 21 | | | | | |
| 16 | Vertical effective | 2.05 | 2.1 | 2.15 | mm | |
| | region of the | | | | | |
| | light-homogenized | | | | | |
| | element 21 | | | | | |
| 17 | Operating | −40 | | 125 | ° C. | |
| | temperature range | | | | | |
| 18 | Storage temperature | −40 | | 125 | ° C. | |
| | range | | | | | |

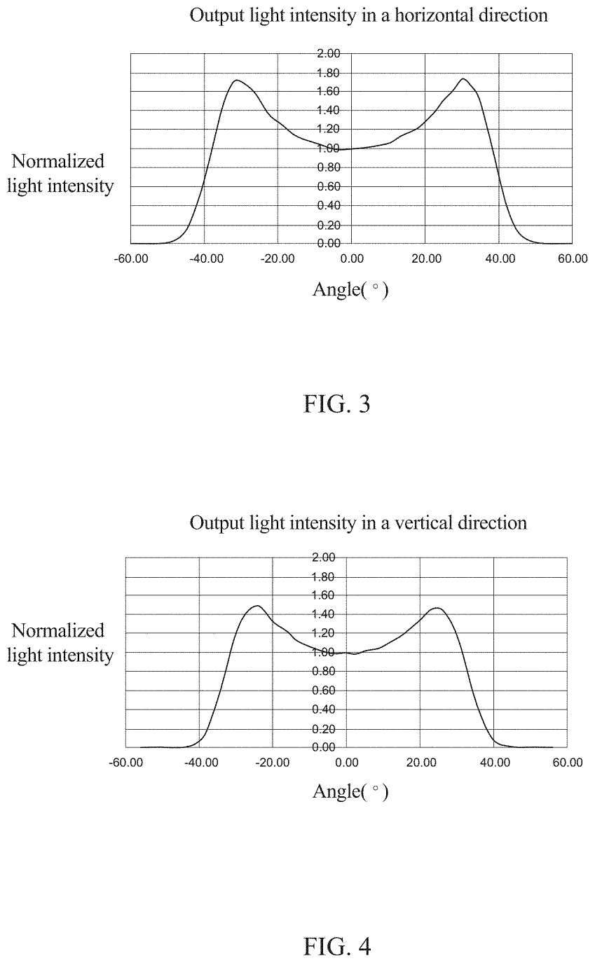

FIG. 3 is the output light intensity in the horizontal direction of the light-homogenized element of the depth camera applied to the application terminal, where the light-homogenized element satisfies specifications shown in the above parameter table.

FIG. 4 is output light intensity in the vertical direction of the light-homogenized element of the depth camera applied to the application terminal, where the light-homogenized element satisfies specifications shown in the above parameter table.

FIG. 7 is output illuminance at 1 m of the light-homogenized element of the depth camera applied to the application terminal, where the light-homogenized element satisfies specifications shown in the above parameter table.

It can be understood that multiple groups of light emission devices 10 and receiving devices 30 may be provided so as to provide a plurality of groups of three-dimensional information, that is, the depth camera may be implemented as a two-shot, three-shot, four-shot or more-shot dimension-increasing information acquisition device, which is not limited herein.

A method for manufacturing the microlens array 212 of the light-homogenized element 21 includes steps described below.

101: one surface of the substrate 211 is divided into regions 103 where the microlens units 2121 are located, where a cross-sectional shape or size of the region 103 where each microlens unit 2121 is located is different, as shown in FIG. 9.

102: the entire microlens array 212 is established with a global coordinate system (X, Y, Z), and each individual microlens unit 2121 is established with a local coordinate system (xi, yi, zi), and a center coordinate of the local coordinate system is (x0, y0, z0).

103: for each microlens unit 2121, a surface profile in a Z-axis direction of each microlens unit 2121 is represented by a curved surface function f:

$$f = \frac{{ρ}^{2}}{R ( 1 + \sqrt{1 - \frac{( 1 + k ) ( {ρ}^{2} )}{{R}^{2}}} )} + {A}_{4} {ρ}^{4} + {A}_{6} {ρ}^{6} + {A}_{8} {ρ}^{8} + … + {Z}_{offset}$$

where ρ²=(xᵢ−x₀)²+(yᵢ−y₀)².

R is a curvature radius of each microlens unit 2121, K is a conical constant, Aj is an aspheric coefficient, and Z_{Offset} is an offset in the Z-axis direction corresponding to the each microlens unit 2121.

It should be noted that the curvature radius R of the microlens unit 2121, the conical constant K, and the aspheric surface coefficient Aj randomly and regularized take values within a corresponding certain range according to the application scene used by the application terminal. On the basis of randomly regularizing the parameters such as the curvature radius R of the microlens unit 2121, the conical constant K and the aspheric coefficient Aj within a predetermined range, where the curvature radius R of the microlens unit 2121, the conical constant K, the aspheric coefficient Aj and other parameters are randomly regularized within a certain range, the coordinate of each microlens unit 2121 is converted from a local coordinate system (xi, yi, zi) into a global coordinate system (X, Y, Z), so that the offset Z_{Offset} in the Z-axis direction corresponding to each microlens unit 2121 is randomly regularized within a certain range; in this way, the surface profile of each microlens unit 2121 in the Z-axis direction is randomly regularized, and the interference of light beams is avoided, thus achieving the light-homogenized effect.

The cross-sectional shapes of the regions where the microlens units 2121 are located are selected from one or more groups of: rectangular, circular, triangular, trapezoidal, polygonal or other irregular shapes and is not limited herein.

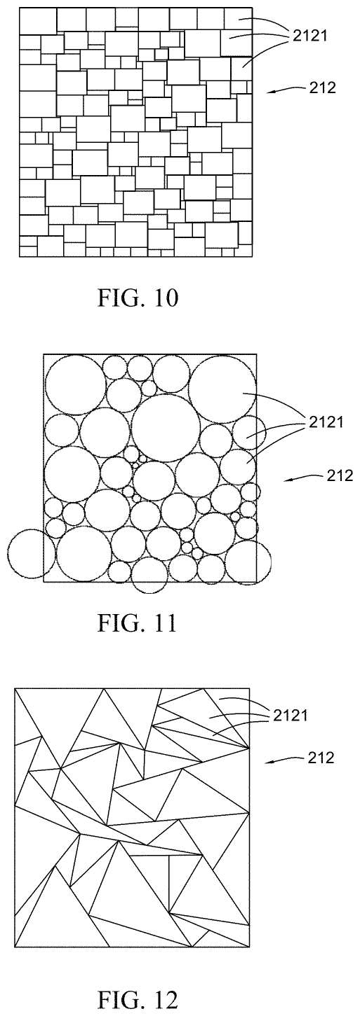

FIG. 10 is a plan view illustrating that the cross-sectional shape of the region where the microlens array 212 of this embodiment is located is rectangular. FIG. 11 is a plan view illustrating that the cross-sectional shape of the region where the microlens array 212 of this embodiment is located is circular. FIG. 12 is a plan view illustrating that the cross-sectional shape of the region where the microlens array 212 of this embodiment is located is triangular.

According to the requirements of different application scenes used by the application terminal, the value ranges of part of parameters or variables of each microlens unit 2121 of the microlens array 212 of the light-homogenized element 21 are approximately as follows: the cross-sectional shape of the region where each microlens unit 2121 is located is implemented as a rectangular cross-section, a circular cross-section or a triangular cross-section, where the size of each microlens unit 2121 takes a value in the range of 3 um to 250 um, the curvature radius R takes a value in the range of ±0.001 to 0.5 mm, the conical constant K takes a value in the range of negative infinity to +100, and the offset Z_{Offset} in the Z-axis direction of each microlens unit 2121 takes a value in the range of −0.1 to 0.1 mm.

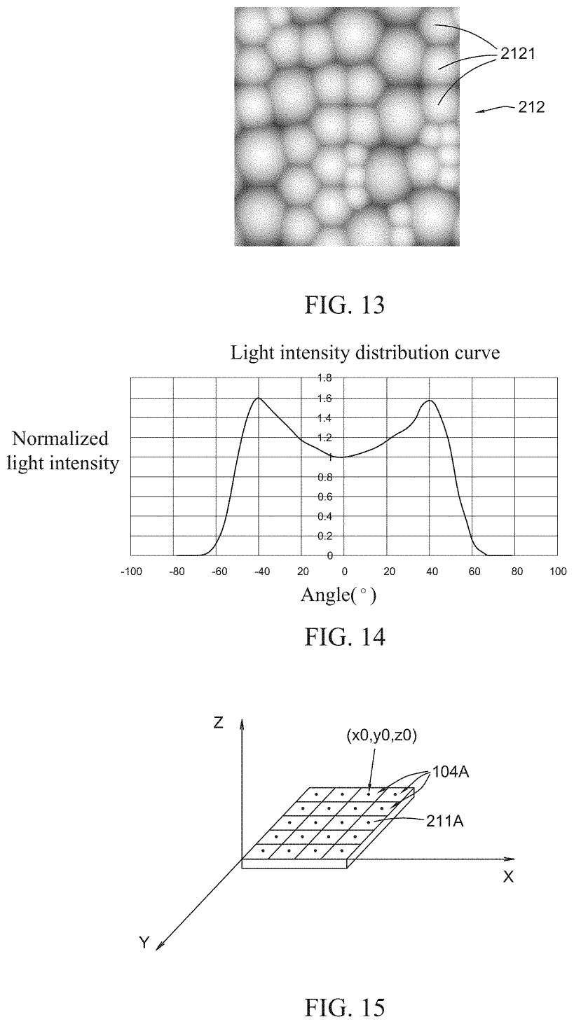

Further, this embodiment provides that part of parameters or variables of each microlens unit 2121 of the microlens array 212 of the light-homogenized element 21 take values within the corresponding certain ranges in the following manners. FIG. 13 is a structural diagram of a microlens array 212 of a light-homogenized element 21 of a depth camera applied to the application terminal. FIG. 14 is a light intensity distribution curve of a light-homogenized element 21 of a depth camera applied to the application terminal.

Corresponding to the requirements of a first application scene used by the application terminal, in step 101, the cross-sectional shape of the region where each microlens unit 2121 is located is implemented as a rectangular cross-section, a circular cross-section or a triangular cross-section. The size of each microlens unit 2121 takes a value in the range of 45 um to 147 um, the curvature radius R takes a value in the range of 0.01 to 0.04 mm, the conical constant K takes a value in the range of −1.03 to −0.97, and the offset Z_{Offset} in the Z-axis direction of each microlens unit 2121 takes a value in the range of −0.002 to 0.002 mm.

Corresponding to the requirements of a second application scene used by the application terminal, in step 101, the cross-sectional shape of the region where each microlens unit 2121 is located is implemented as a rectangular cross-section, a circular cross-section or a triangular cross-section. The size of each microlens unit 2121 takes a value in the range of 80 um to 125 um, the curvature radius R takes a value in the range of 0.02 to 0.05 mm, the conical constant K takes a value in the range of −0.99 to −0.95, and the offset Z_{Offset} in the Z-axis direction of each microlens unit 2121 takes a value in the range of −0.003 to 0.003 mm.

Corresponding to the requirements of a third application scene used by the application terminal, in step 101, the cross-sectional shape of the region where each microlens unit 2121 is located is implemented as a rectangular cross-section, a circular cross-section or a triangular cross-section. The size of each microlens unit 2121 takes a value in the range of 28 um to 70 um, the curvature radius R takes a value in the range of 0.008 to 0.024 mm, the conical constant K takes a value in the range of −1.05 to −1, and the offset Z_{Offset} in the Z-axis direction of each microlens unit 2121 takes a value in the range of −0.001 to 0.001 mm.

Corresponding to the requirements of a fourth application scene used by the application terminal, in step 101, the cross-sectional shape of the region where each microlens unit 2121 is located is implemented as a rectangular cross-section, a circular cross-section or a triangular cross-section. The size of each microlens unit 2121 takes a value in the range of 50 um to 220 um, the curvature radius R takes a value in the range of −0.08 to 0.01 mm, the conical constant K takes a value in the range of −1.12 to −0.95, and the offset Z_{Offset} in the Z-axis direction of each microlens unit 2121 takes a value in the range of −0.005 to 0.005 mm.

As shown in FIGS. 15 to 20, in a second implement manner of an embodiment, a design method of a microlens array 212A of another light-homogenized element 21A is further provided and includes steps described below.

201: a surface of the substrate 211A is divided into regions 104A where the microlens units 2121A are located, where a cross-sectional shape or size of the region 104A where each microlens unit 2121A is located is substantially identical, as shown in FIG. 15.

202: the entire microlens array 212A is established with a global coordinate system (X, Y, Z), and each individual microlens unit 2121A is established with a local coordinate system (xi, yi, zi), and a center coordinate of the corresponding region 104A is (x0, y0, z0), where the center coordinate of the region 104A represents an initial center position of the microlens unit 2121A corresponding to the region 104A.

203: a true center position of each microlens unit 2121A is set to add a random offset X_{Offset} and Y_{Offset} in the X-axis direction and Y-axis direction to the center coordinate of the region 104A, respectively.

204: for each microlens unit 2121A, a surface profile in a Z-axis direction of each microlens unit 2121 is represented by a curved surface function f:

$$f = \frac{{ρ}^{2}}{R ( 1 + \sqrt{1 - \frac{( 1 + k ) ( {ρ}^{2} )}{{R}^{2}}} )} + {A}_{4} {ρ}^{4} + {A}_{6} {ρ}^{6} + {A}_{8} {ρ}^{8} + … + {Z}_{offset}$$

where ρ²=(xᵢ−x₀−X_{Offset})²+(yᵢ+y₀−Y_{Offset})².

R is a radius of curvature of each microlens unit 2121A, K is a conical constant, Aj is an aspheric coefficient, and Z_{Offset} is an offset in the Z-axis direction corresponding to the each microlens unit 2121A.

It should be noted that the curvature radius R of the microlens unit 2121A, the conical constant K, and the aspheric surface coefficient Aj randomly and regularized take values within a corresponding certain range according to the application scene used by the application terminal. On the basis of randomly regularizing the parameters such as the curvature radius R of the microlens unit 2121A, the conical constant K and the aspheric coefficient Aj within a predetermined range, where the curvature radius R of the microlens unit 2121A, the conical constant K, the aspheric coefficient Aj and other parameters are randomly regularized within a certain range, the coordinate of each microlens unit 2121A is converted from a local coordinate system (xi, yi, zi) into a global coordinate system (X, Y, Z), so that the offset Z_{Offset} in the Z-axis direction corresponding to each microlens unit 2121A is randomly regularized within a certain range; in this way, the surface profile of each microlens unit 2121A in the Z-axis direction is randomly regularized, and the interference of light beams is avoided, thus achieving the light-homogenized effect.

In step S101, the cross-sectional shapes of the regions where the microlens units 2121A are located are selected from one group of: rectangular, circular, triangular, trapezoidal, polygonal or other irregular shapes and is not limited herein.

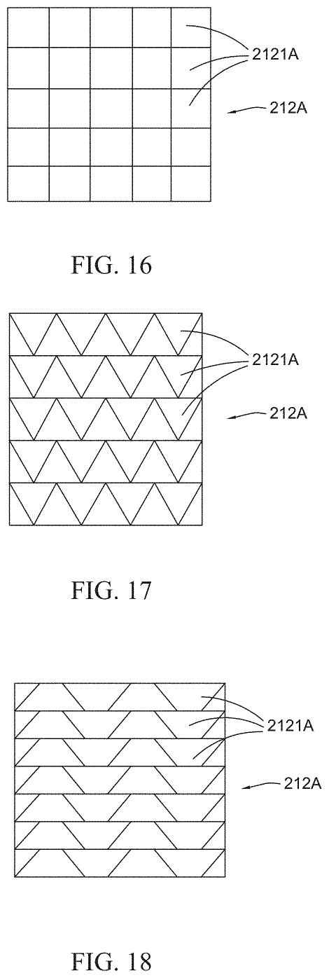

FIG. 16 is a plan view illustrating that the cross-sectional shape of a region where the microlens array 212A of this embodiment is located is quadrate. FIG. 17 is a plan view illustrating that the cross-sectional shape of the region where the microlens array 212A of this embodiment is located is triangular. FIG. 18 is a plan view illustrating that the cross-sectional shape of a region where the microlens array 212A of this embodiment is located is trapezoidal.

According to the requirements of the different application scenes used by the application terminal, the value ranges of part of parameters or variables of each microlens unit 2121A of the microlens array 212A of the light-homogenized elements 21 are also preset accordingly.

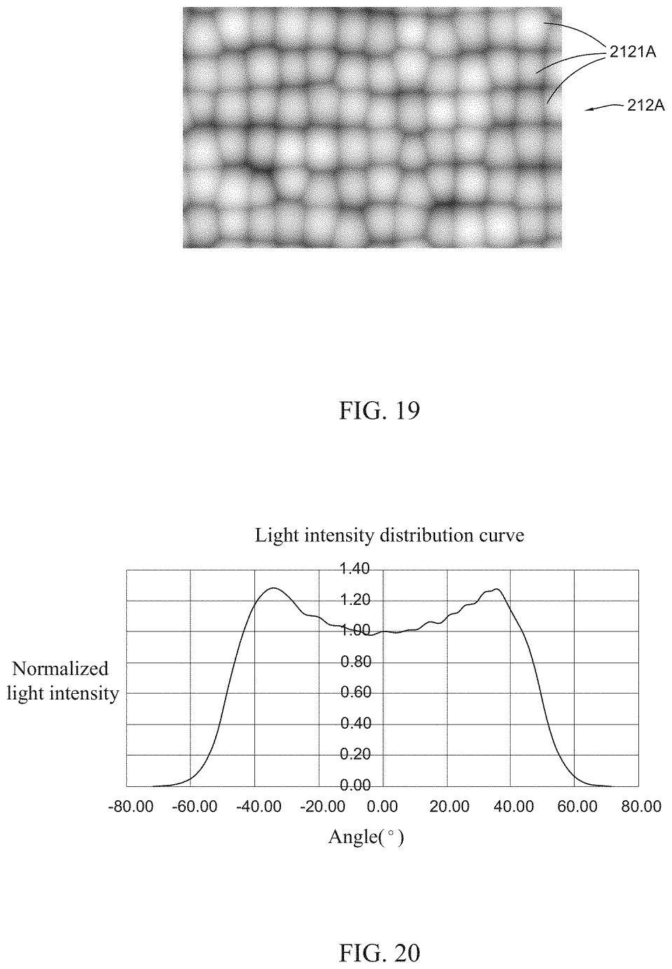

Further, this embodiment provides that part of parameters or variables of each microlens unit 2121A of the microlens array 212A of the light-homogenized element 21 take values within corresponding certain ranges in the following manners. FIG. 19 is a structural diagram of a microlens array 212A of a light-homogenized element 21 of a depth camera applied to the application terminal. FIG. 20 is a light intensity distribution curve of a microlens array 212A of a light-homogenized element 21 of a depth camera applied to the application terminal.

Corresponding to the requirements of a fifth application scene used by the application terminal, in step 201, the cross-sectional shape of the region where each microlens unit 2121A is located is implemented as a rectangular cross-section, a circular cross-section or a triangular cross-section. The size of each microlens unit 2121A takes a value of 32 um, the curvature radius R takes a value in the range of 0.009 to 0.013 mm, the conical constant K takes a value in the range of −0.96 to −0.92, an added random offset X_{Offset} in the X-axis direction of each microlens unit 2121A takes a value in the range of −15 to 15 um, an added random offset Y_{Offset} in the Y-axis direction of each microlens unit 2121A takes a value in the range of −20 to 20 um, and the offset Z_{Offset} in the Z-axis direction of each microlens unit 2121A takes a value in the range of −0.001 to 0.001 mm.

Corresponding to the requirements of a sixth application scene used by the application terminal, in step 201, the cross-sectional shape of the region where each microlens unit 2121A is located is implemented as a rectangular cross-section, a circular cross-section or a triangular cross-section. The size of each microlens unit 2121A takes a value of 35 um, the curvature radius R takes a value in the range of 0.01 to 0.015 mm, the conical constant K takes a value in the range of −0.99 to −0.93, an added random offset X_{Offset} in the X-axis direction of each microlens unit 2121A takes a value in the range of −23 to 23 um, an added random offset Y_{Offset} in the Y-axis direction of each microlens unit 2121A takes a value in the range of −16 to 16 um, and the offset Z_{Offset} in the Z-axis direction of each microlens unit 2121A takes a value in the range of −0.001 to 0.001 mm.

Corresponding to the requirements of a seventh application scene used by the application terminal, in step 201, the cross-sectional shape of the region where each microlens unit 2121A is located is implemented as a rectangular cross-section, a circular cross-section or a triangular cross-section. The size of each microlens unit 2121A takes a value of 80 um, the curvature radius R takes a value in the range of 0.029 to 0.034 mm, the conical constant K takes a value in the range of −1 to −0.92, an added random offset X_{Offset} in the X-axis direction of each microlens unit 2121A takes a value in the range of −37 to 37 um, an added random offset Y_{Offset} in the Y-axis direction of each microlens unit 2121A takes a value in the range of −40 to 40 um, and the offset Z_{Offset} in the Z-axis direction of each microlens unit 2121A takes a value in the range of −0.005 to 0.005 mm.

Corresponding to the requirements of an eighth application scene used by the application terminal, in step 201, the cross-sectional shape of the region where each microlens unit 2121A is located is implemented as a rectangular cross-section, a circular cross-section or a triangular cross-section. The size of each microlens unit 2121A takes a value of 75 um, the curvature radius R takes a value in the range of 0.025 to 0.035 mm, the conical constant K takes a value in the range of −1.2 to −0.96, an added random offset X_{Offset} in the X-axis direction of each microlens unit 2121A takes a value in the range of −45 to 45 um, an added random offset Y_{Offset} in the Y-axis direction of each microlens unit 2121A takes a value in the range of −45 to 45 um, and the offset Z_{Offset} in the Z-axis direction of each microlens unit 2121A takes a value in the range of −0.004 to 0.004 mm.

The depth camera may be applied to different application terminals according to different application scenes, where the image information of the target scene acquired by the depth camera is sent to the application terminal, and the application terminal processes the image information and gives corresponding actions or results. The application terminals include but are not limited to vivo detection, mobile phones, face recognition, iris recognition, AR/VR technology, robot recognition and robot hedging, smart homes, automatic drive vehicles or unmanned aerial vehicle technology, etc., which have a wide range of applications and are suitable for diversified application scenes.

In this embodiment, the application terminal may be implemented as a face recognition system, where the depth camera is used for capture three-dimensional image information of a face, and the application terminal recognizes a target face based on the image information and makes a corresponding response. In an embodiment, the application terminal may be implemented as a gesture recognition system, where the depth camera is used for capture three-dimensional image information of a gesture, and the application terminal recognizes the gesture based on the image information and makes a corresponding response. In an embodiment, the application terminal may be implemented as smart home, where the depth camera is used for capture three-dimensional image information of an indoor user, and the application terminal performs an on and off or an operation mode of the corresponding intelligent furniture based on the image information. In an embodiment, the application terminal may also be implemented as a security monitoring system, an automatic drive vehicle, an unmanned aerial vehicle, a VR/AR device, and the like, which is not limited herein.

In the description of the specification, the description of reference terms “an embodiment”, “some embodiments”, “example”, “specific example”, or “some examples” and the like means a specific characteristic, a structure, a material or a feature described in connection with the embodiment or the example are included in at least one embodiment or example of the present disclosure. In the specification, the illustrative description of the preceding terms does not necessarily refer to the same embodiment or example. Moreover, the described specific features, structures, materials or characteristics may be combined in an appropriate manner in any one or more embodiments or examples. In addition, the different embodiments or examples described in this specification and the features of the different embodiments or examples may be combined and combined by those skilled in the art without contradicting each other.

It is to be understood by those skilled in the art that the embodiments of the present disclosure described in the above description and drawings are by way of example only and not intended to limit the present disclosure. The purpose of the present disclosure has been achieved completely and efficiently. The function and structural principle of the present disclosure have been shown and illustrated in the embodiments, and the embodiments of the present disclosure may be altered or modified without departing from the principle.

What is claimed is:

1. An optical component, applied to a depth camera having a light source, comprising:
a light-homogenized element having a microlens array, wherein the light-homogenized element is arranged on a light beam propagation path of the light source, and is used for modulating a light field emitted by the light source of the depth camera to form a light beam which is not interfered to form light and dark stripes; and
a receiving lens, wherein the receiving lens is adapted to a field angle of the light-homogenized element, and the receiving lens is configured to allow at least a part of the light beam passing through the light-homogenized element to enter the receiving lens after being reflected by a target object.

2. The optical component of claim 1, wherein the field angle of the receiving lens in a horizontal direction and a vertical direction both take a value in a range of 1° to 150°.

3. The optical component of claim 2, wherein the field angle of the receiving lens in the horizontal direction and the vertical direction are greater than or equal to 70°.

4. The optical component of claim 1, wherein a relative illuminance of the light-homogenized element in a central preset field angle range gradually decreases toward a center direction of the light-homogenized element, and a relative illuminance of the receiving lens in the central preset field angle range gradually increases toward a center direction of the receiving lens.

5. The optical component of claim 4, wherein the central preset field angle range in the horizontal direction and the vertical direction are 0° to 20°.

6. The optical component of claim 1, wherein a range of a focal length of the receiving lens is 1 mm to 20 mm.

7. The optical component of claim 1, wherein a range of an F number of the receiving lens is 0.6 to 10.

8. The optical component of claim 1, wherein an imaging circle diameter of the receiving lens is greater than 6 mm.

9. The optical component of claim 1, wherein a range of an optical distortion of the receiving lens is −10% to 10%.

10. The optical component of claim 1, wherein the receiving lens is configured to adapt to a light source with a spectrum of 800 to 1100 nm.

11. The optical component of claim 1, wherein a total track length of the receiving lens is less than or equal to 100 mm, and a back focal length of the receiving lens is greater than or equal to 0.1 mm.

12. The optical component of claim 1, wherein the field angle of the light-homogenized element in a horizontal direction and a vertical direction both take a value in a range of 1° to 150°.

13. The optical component of claim 12, wherein an output light intensity distribution of the light-homogenized element in the horizontal direction and the vertical direction are expressed as cos\hat{ }(−n) by a relationship between an output light intensity and an angle, and n is preset to take a value in a range of 0 to 20.

14. The optical component of claim 1, wherein a transmittance of the light-homogenized element is greater than 80%.

15. The optical component of claim 14, wherein a ratio of a light power in the field angle to a total power transmitted through the light-homogenized element is greater than 60%.

16. The optical component of claim 1, wherein a total thickness of the light-homogenized element is preset within a range of 0.1 mm to 10 mm, and a thickness of the microlens array is preset between Sum and 300 um.

17. The optical component of claim 1, wherein an overall size of the light-homogenized element is preset between 0.1 and 300 mm, and a size range of a length of a side of an effective region of the microlens array is preset to be between 0.05 and 300 mm.

18. The optical component of claim 1, wherein the light-homogenized element comprises a substrate, and the microlens array is formed on one surface of the substrate.
